(19) United States
(12) Patent Application Publication
(10) Pub. No.: US 2021/0000150 A1
(43) Pub. Date: Jan. 7, 2021

(54) Fruit Sauce and Process for Making Same

(71) Applicant: Nicholas Macrie, Hammonton, NJ (US)

(72) Inventor: Nicholas Macrie, Hammonton, NJ (US)

(21) Appl. No.: 16/920,507

(22) Filed: Jul. 3, 2020

Related U.S. Application Data
(60) Provisional application No. 62/870,114, filed on Jul. 3, 2019.

(51) Int. Cl. A23L 19/00; A23L 21/12; A23L 21/15; A23L 29/231; A23L 29/30

(52) U.S. Cl. CPC A23L 19/09; A23L 21/12; A23V 2002/00; A23L 29/231; A23L 29/30; A23L 21/15

(57) ABSTRACT

A method for creating a fruit jelly food product having a viscous consistency, including weighing and proportioning initial ingredients, modulating the size, texture, or temperature of the initial ingredients, combining the initial ingredients into a fruit mixture and heating, adding a gelling agent to the fruit mixture to obtain a gel-enhanced mixture, adding citric acid and lemon juice to the gel-enhanced mixture to obtain a citrus-enhanced mixture and heating, allowing the citrus-enhanced mixture to achieve thermodynamic equilibrium, and confirming the pH of the citrus-enhanced mixture is less than or equal to about 3.6 and sugar content of about 25 degrees Brix.

### CROSS-REFERENCE TO RELATED APPLICATIONS

This application claims the benefit of earlier filed U.S. Provisional Application No. 62/870,114, filed on Jul. 3, 2019, which is incorporated by reference herein in its entirety.

### BACKGROUND

With diversification of foods, foods having various shapes, physical properties and textures have been required. Particularly, interest has recently been shown towards quasi-solid fruit creations with highly viscous texture and consistency as important physical properties for the purpose of designing foods. Fruits may be a desirable base ingredient due to their natural and organic qualities. Natural fruit-based creations may serve as a contrast to foods that are industrialized with a high degree of artificial ingredients.

In food processing, natural macromolecules such as agar, gelatin, gellan gum, xanthan gum, locust bean gum, carrageenan, pectin, sodium alginate, Tamarind seed gum, psyllium seed gum, microcrystal cellulose, curdlan, and starch; or synthetic macromolecules such as carboxymethyl cellulose (CMC) or methyl cellulose are commonly used as gelling agents. These gelling agents may increase the viscosity of the food thus giving it a more quasi-solid texture.

A process that is capable of creating a natural organic fruit based food having high viscosity and or malleability may be desirable for a number of culinary applications.

### SUMMARY OF DISCLOSURE

A method for creating a fruit jelly food product having a viscous consistency, including weighing and proportioning initial ingredients, modulating the size, texture, or temperature of the initial ingredients, combining the initial ingredients into a fruit mixture and heating, adding a gelling agent to the fruit mixture to obtain a gel-enhanced mixture, adding citric acid and lemon juice to the gel-enhanced mixture to obtain a citrus-enhanced mixture and heating, allowing the citrus-enhanced mixture to achieve thermodynamic equilibrium, and confirming the pH of the citrus-enhanced mixture is less than or equal to about 3.6 and sugar content of about 25 degrees Brix.

### BRIEF DESCRIPTION OF THE DRAWINGS

FIG. 1 is a flowchart describing a process according to an aspect of the present disclosure.

FIG. 2 is a list of ingredients according to one aspect of the present disclosure.

### DETAILED DESCRIPTION

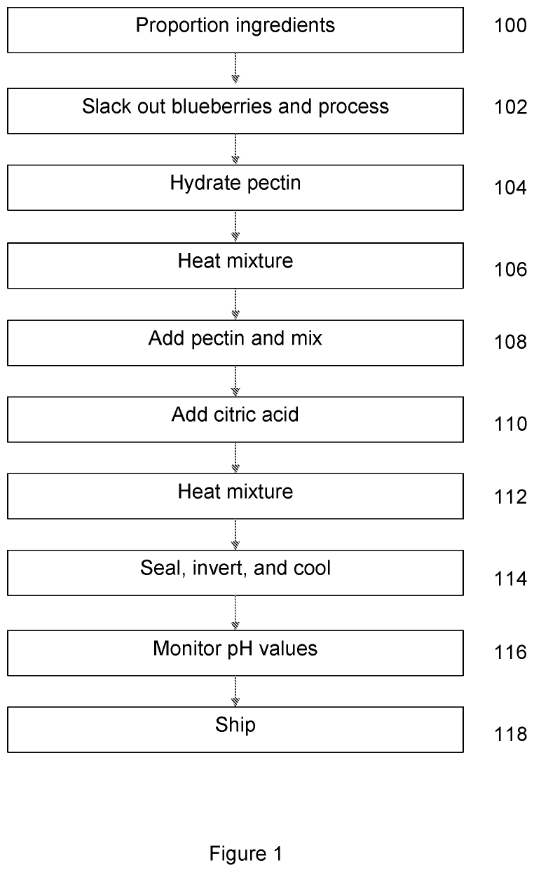

FIG. 1 is a flow chart describing a process according to one aspect of the present disclosure. In Step 100, the ingredients may be prepared and proportioned. This may involve selecting the desired ingredients and performing any necessary preparatory actions. Desired ingredients may include fruits, fruit products such as concentrates, liquids such as water, gelling agents or similar chemicals. Preparatory actions may include cleaning, skinning, pruning, pounding to the necessary configuration. Once the materials are prepared, they may be proportioned according to their mass or weight. According to one aspect of the present disclosure, the ingredients for proportioning may include blueberries, blueberry juice concentrate, blueberry puree, water and sugar. Preparatory actions may be desirable, including cleaning and freezing. Freezing may provide a benefit by rupturing plant cells, which may lead to a more favorable flavor or texture for the end product. Cleaning may be done by hand or with the aid of machinery. Cleaning may include the use of water, by submerging the ingredients and physically agitating them to remove any foreign debris. Preparatory actions may also include sorting the fruit ingredients according to size.

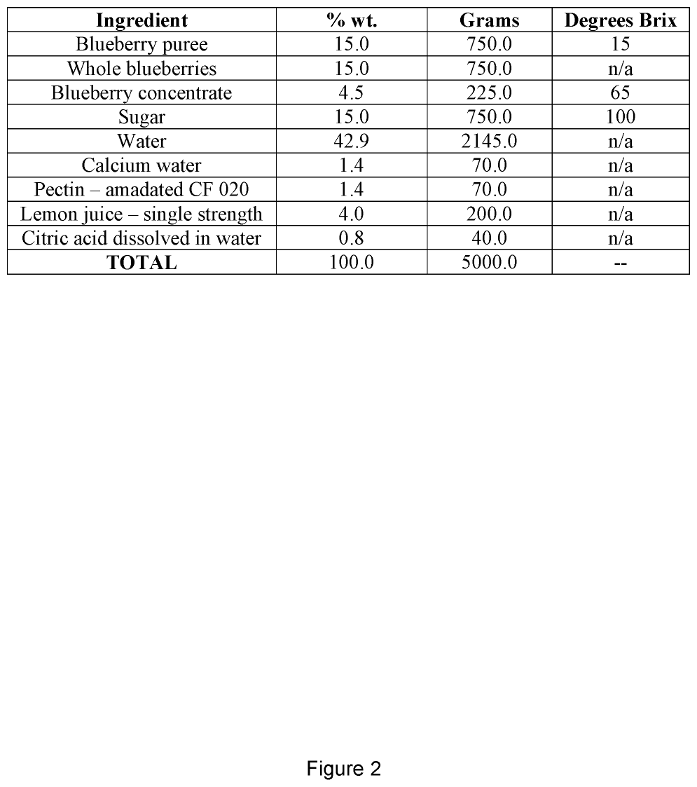

According to one aspect of the present disclosure, assuming in one non-limiting example, a total ingredient mass of 5 kg (including ingredients added after Step 100), the ingredient values for Step 100 may be as shown in FIG. 2 and as follows: 750 g blueberries; 225 g blueberry concentrate; 750 g blueberry puree; 70 g calcium water; 2145 g water; and 750 g sugar. Calcium water may be added in Step 100 to assist in strengthening the gelling properties of the final product. Without the addition of calcium water, the final product may form a less cohesive, and less firm gel. Despite this, calcium water is optional to include. Calcium water can be obtained by adding calcium to water then mixing. According to one aspect of the present disclosure, calcium water may be obtained by adding monocalcium phosphate powder to a volume water at a ratio of one teaspoon monocalcium phosphate to one cup of water and blended or mixed until evenly distributed. The blueberry puree may have a sugar content of approximately 15 degrees Brix. The blueberry concentrate may have a sugar content of 65 degrees Brix. Once the desired proportions are prepared and measured out, Step 100 may be complete.

In Step 102, the ingredients may be further processed. Further processing may be cutting, mashing, or physically altering the size, temperature, or consistency of one or more ingredients, prior to their combination with each other. According to one aspect of the present disclosure, the blueberries may be slacked out if necessary and diced. In the case of frozen blueberries, slacking out may involve the process of moderating the temperature of the blueberries such that their temperature is allowed to gradually increase to facilitate even heat penetration during later steps. One example of slacking may include leaving the exposing the frozen berries to air held above freezing within a refrigeration unit for a predetermined period of time. The dicing may be done by hand with a kitchen utensil, or more commonly, may be aided by machinery such as a dicer including an “Urshel” dicer. The desired size may be 3/16″, as this may allow fruit bits to distribute about the final gel product, thus giving the final product a real-fruit feel. The sizes to which the fruit ingredients are diced is generally optional, depending on preference.

In Step 104 pectin, which is a commercially available food substance, typically in powder form may be hydrated prior to combining with the other ingredients. Hydrating the pectin may involve dissolving the white pectin powder into a volume of water, thus causing the mixture to form a gel. The mixture may be blended by hand or with the aid of machinery to achieve a gel-like consistency without lumps. According to one aspect of the present disclosure, the pectin may be hydrated into a volume of water under high shear. High shear may involve mixing with mechanical components with high energy and velocities, such as a blender with blades that spin in excess of 15,000 rpm. Mixing with high shear may provide a more desirable texture and consistency with the final product.

In Step 106, the ingredients proportioned in Step 100 may be combined and mixed. This may be done in a plastic or metallic mixing bowl, and the mixing may be done with traditional kitchen equipment such as whisks or spoons, or mechanized mixers may also be used. Once mixed, the mixture may be heated to a desired temperature. According to one aspect of the present disclosure, the blueberry, blueberry concentrate, blueberry puree, water and sugar ingredients prepared in Step 100 may be mixed by utilizing a scrape service agitator and heated to 180 degrees Fahrenheit.

In Step 108, once the mixture has achieved the desired temperature, the hydrated pectin prepared in Step 104 may be added to the mixture of Step 106, and further mixed to a desired consistency. This may be done at a predetermined temperature. According to one aspect of the present disclosure, once the blueberry, blueberry concentrate, blueberry puree, sugar and water mixture is 180 degrees Fahrenheit, 70 g of hydrated pectin described in Step 104 may be added and further mixed until the consistency is smooth. The temperature may continue to be raised after the addition of the hydrated pectin. Adding the hydrated pectin when the blueberry, blueberry concentrate, blueberry puree, sugar and water mixture is at different temperatures may yield different texture or consistency results.

In Step 110, citric acid may be added to the heated mixture described in Steps 106 and 108. Citric acid may be added in a number of ways, including but not limited to, adding the juice of citrus plants, citrus concentrate, or crystallized citric acid extract, such as can be found in powered or crystalline form. It may be desirable to dissolve citric acid in water prior to adding to the fruit puree prepared in Steps 106 and 108. Citric acid extract or concentrate may also be combined directly with the juice of citrus fruits before being added, although this is not necessary and depends on preference. According to one aspect of the present disclosure, about 40 grams of citric acid may be dissolved into 1000 g grams of water, which may then be added to 200 g of lemon juice and mixed well. From this citric acid/lemon juice/water mixture, 40 g may then be added to the heated blueberry fruit mixture described in Steps 106 and 108 once said mixture is at or about 200 degrees Fahrenheit.

In Step 112, the new mixture of fruit ingredients, pectin, and citric acid may be further heated to a desired temperature. Once the desired temperature is achieved, the mixture may be held at that temperature for desired time before being allowed to cool to a lower desired temperature. According to one aspect of the present disclosure, the mixture obtained after Step 110 may be further heated to 212 degrees Fahrenheit and then allowed to cool to about 190 degrees Fahrenheit. The temperature may then be held at 190 degrees Fahrenheit while Step 114 is completed.

In Step 114, the mixture produced by Step 112 may then be placed into packages or containers, and sealed therein. The packaging and sealing may take place with a minimum product temperature of 180 degrees Fahrenheit for safety and contamination reasons. There are various types of packaging and methods for sealing that may be applicable. For example, there may be a glass container sealed with a metal cap having a plastic liner. There may be metal cans sealed with traditional can sealing methods. There may be plastic containers that utilize air-tight plastic membranes that adhere to the plastic container, such as those involved with induction sealing. The size or volume of the packaging may vary, depending on economic or commercial considerations. The package containing the mixture may then be inverted or tilted to ensure all interior surfaces of the packages contact with the food product having a temperature of no less than 180 degrees Fahrenheit. This may be done to disinfect the package interior. The inversion or tilting may be held for a specified time before cooling begins. Cooling may involve forced cooling or ambient cooling. Ambient cooling may involve exposing the sealed package to open air held at a predetermined temperature. Forced cooling may include exposing the package to intentional cooling mechanisms such as forced convection, evaporation, and other cooling technologies.

According to one aspect of the present disclosure, the mixture produced by Step 112 may be placed into an 8.0 oz glass or plastic jar with plastisol lined metal cap, or a sealed metal can with a lid. The food product may be held above 190 degrees temperature during the packaging process. The sealed package may then be inverted or tilted with the food product held above 190 degrees Fahrenheit for at least 5 minutes to ensure all interior surfaces are disinfected. Although the minimum product temperature is 180 degrees Fahrenheit throughout Step 114, it may be beneficial to start Step 114 at a higher product temperature to allow room for cooling when the food product contacts the package material at a lower temperature. If Step 114 is started when the product is already at the minimum temperature of 180 degrees Fahrenheit, the product temperature may dip below 180 degrees Fahrenheit and compromise the effectiveness and purpose of Step 114. Cooling may be achieved by forced cooling by blowing cool air over the packages. This may be done with the use of a fan or a wind-tunnel type apparatus.

In Step 116, a sample of the mixture produced in Step 112 may be set aside for quality control purposes, where one or more quantities may be monitored. Sample quantities include pH value, viscosity, sugar content, and similar quantities. Sugar content may be expressed in a unit known as Degrees Brix, which references the percent content of sugar. If the sample deviates from the allowable tolerances, remedial action may be taken prior to shipping product to the end consumer. According to one aspect of the present disclosure, a sample of the blueberry mixture produced in Step 112 may be set aside and measured for pH values after thermodynamic equilibrium is reached. It may also be measured for sugar content. In this aspect of the present disclosure, the desired pH may be at or lower than 3.6, with a sugar content of 25 degrees Brix (or 25% total sugar content).

In Step 118, the product may be shipped to the consumer.

FIG. 2 is a sample ingredient list including respective proportions according to an aspect of the present disclosure in one non-limiting example wherein the total batch size is 5 kg. The steps shown on the figure may be a condensed version of the process substantially described above in FIG. 1.

1. A method for creating a fruit jelly food product having a viscous consistency, the method comprising the steps of:
a) weighing and proportioning initial ingredients comprising:
i) blueberries at approximately 15% wt.;
ii) blueberry puree at approximately 15% wt.;
iii) blueberry concentrate at approximately 4.5% wt.;
iv) water at approximately 42.9% wt.;
v) calcium water at approximately 1.4% wt.; and
vi) sugar at approximately 15% wt.;
b) modulating the size, texture, or temperature of the initial ingredients;
c) combining the initial ingredients into a fruit mixture and heating to approximately 180 F;
d) adding a gelling agent comprising hydrated pectin at 1.4% wt. to the fruit mixture to obtain a gel-enhanced mixture;
e) adding citric acid at 0.8% wt. and lemon juice 4.0% wt. to the gel-enhanced mixture to obtain a citrus-enhanced mixture and heating to approximately 212 F;
f) allowing the citrus-enhanced mixture to achieve thermodynamic equilibrium; and
g) confirming the pH of the citrus-enhanced mixture is less than or equal to about 3.6 and sugar content of about 25 degrees Brix.

2. The method of claim 1, wherein the blueberries are frozen.

3. The method of claim 1, wherein the hydrated pectin is obtained by hydration under high shear.

4. A fruit jelly food product created using the method of claim 1.
